(19) United States
(12) Patent Application Publication
(10) Pub. No.: US 2026/0001790 A1
(43) Pub. Date: Jan. 1, 2026

(54) FARADIC POROSITY CELL

(71) Applicant: PowerTech Water Inc., Lexington, KY (US)

(72) Inventors: Lindsay Boehme, Iowa City, IA (US); Cameron Lippert, Lexington, KY (US); James Landon, Lexington, KY (US); Alan Rassoolkhani, Lexington, KY (US); Jeffrey Rentschler, Lexington, KY (US); Collin Dunn, Richmond, KY (US)

(21) Appl. No.: 19/311,614

(22) Filed: Aug. 27, 2025

Related U.S. Application Data
(63) Continuation-in-part of application No. 17/369,346, filed on Jul. 7, 2021, now Pat. No. 12,421,616.
Application No. 17/369,346 is a continuation-in-part of application No. 16/520,340, filed on Jul. 23, 2019, now Pat. No. 11,117,818.
Application No. 16/520,340 is a continuation-in-part of application No. 16/417,574, filed on May 20, 2019, now abandoned.
Application No. 16/417,574 is a continuation-in-part of application No. 15/984,290, filed on May 18, 2018, now abandoned.
(60) Provisional application No. 62/508,351, filed on May 18, 2017.
(60) Provisional application No. 62/702,286, filed on Jul. 23, 2018.
(60) Provisional application No. 62/702,286, filed on Jul. 23, 2018.
(60) Provisional application No. 62/758,433, filed on Nov. 9, 2018.
(60) Provisional application No. 62/758,433, filed on Nov. 9, 2018.

(51) Int. Cl. C02F 1/469; C02F 1/28; C02F 101/12; C02F 101/16; C02F 101/20; C02F 101/22; C02F 103/06

(52) U.S. Cl. CPC C02F 1/4691; C02F 1/283; C02F 2101/12; C02F 2101/16; C02F 2101/206; C02F 2101/22; C02F 2103/06; C02F 2201/46

(57) ABSTRACT

The present invention is directed to an electrochemical device for at least partially removing or reducing a target ionic species from an aqueous solution using faradaic immobilization, the electrochemical device including at least one first electrode and at least one second electrode with different void fraction and surface area properties, due to differences in void fraction (also referred to as void ratio) of the at least one first and the at least one second electrode, water flows through an electrode with a high porosity, while the aqueous solution does not flow through an electrode with a low porosity. The asymmetry of the electrodes provides a desired voltage distribution across the device, which equates to a different voltage at each electrode, to control the speciation of the target ionic species at the anode and the cathode.

### FEDERAL FUNDING

This invention was made with government support under DE-SC0021567 awarded by the Department of Energy. The government has certain rights in the invention.

### BACKGROUND

The present disclosure relates to electrochemical devices, and more particularly, to faradic porosity electrochemical devices.

Various methods are used to remove heavy metals and other target species from wastewater and process water. Such methods include, for example, chemical precipitation, ion exchange, adsorption, membrane filtration, reverse osmosis, and electrochemical treatment.

Electrochemical devices for removing heavy metals include one or more pairs of electrodes, an anode and a cathode, that remove or reduce the concentration of target species from an input stream and thereby provide an output stream with decreased content of the target species. In particular, when a sufficient external voltage (i.e., potential) is applied to the electrodes, non-spontaneous chemical reactions occur that reduce the concentration of target species (e.g., metal ions, halide ions, derivatives of target metals or target halides, or particulate metals) in the aqueous solution.

Depending on the process conditions, e.g., applied voltage, pH, type and concentration of target species, electrode spacing, and cell design, target species are selectively removed from the aqueous solution by various processes, including physical adsorption to an electrode; electrical attraction (i.e., capacitive adsorption) to an electrode; and/or electron transfer reactions that directly or indirectly create new target species (i.e., Faradaic reactions) that become immobilized on an electrode.

### SUMMARY

According to one or more embodiments, an electrochemical device for at least partially removing or reducing a target ionic species from an aqueous solution using faradaic immobilization includes at least one first electrode comprising an activated carbon film having a void fraction of about 10% to about 75% and a surface area of about 600 square meters per gram to about 2,000 square meters per gram; and at least one second electrode comprising a carbon-based material having a void fraction of about or greater than 95% and a surface area of about 0.1 square meters per gram to about 5 square meters per gram.

### BRIEF DESCRIPTION OF THE DRAWINGS

FIG. 1 illustrates a device with stacked cell design.

FIG. 2 illustrates a rolled cell design.

### DETAILED DESCRIPTION

Electrochemical devices with carbon-based (i.e., carbonaceous) electrodes provide highly efficient and environmentally friendly processes to remove and reduce the content of target species (e.g., heavy metals and other targets) from wastewater. By using the Pourbaix diagram (or potential/pH diagram) of the target species, which illustrates possible stable (equilibrium) phases of a target species in an aqueous electrochemical system, the desired applied potential (E) can be selected to selectively remove the target species on the anode or cathode.

Conventional electrochemical devices used for removing metals and other ions from aqueous feed streams utilize the same carbon electrode material for both the anode and cathode, which simplifies manufacturing, reduces costs, and ensures consistent conductivity, pore structure, and surface chemistry. This uniformity improves predictability of electrochemical behavior, enhances reproducibility in metal removal, and minimizes performance differences during regeneration, leading to longer and more stable system operation.

However, controlling the speciation of metals during electrochemical removal is inherently challenging. The potential applied to each electrode is influenced not only by the total voltage supplied to the cell, but also by the complex interplay between electrode surface chemistry, ionic strength, conductivity, and the composition of the influent aqueous stream. Small variations in these parameters can shift local pH and redox potential, moving the system outside the desired Pourbaix operating region and altering metal speciation. In practice, this means that even nominally identical electrodes can exhibit different local electrochemical environments, leading to variability in removal efficiency. Moreover, precise voltage control is complicated by changes in solution resistance, electrode fouling, and accumulation of reaction products over time, all of which can alter the effective potential at the electrode surfaces. Maintaining consistent speciation control therefore requires continuous monitoring and dynamic adjustment of operating conditions.

Accordingly, described herein are electrochemical devices, systems, and methods of making and devices and systems, that include asymmetric electrodes, in which the pair of electrodes (i.e., the anode and the cathode) are different carbon materials with different properties described herein. The particular asymmetry of the electrodes provides an optimal voltage distribution across the device, which equates to a different voltage at each electrode, to control the speciation of the target ionic species at the anode and the cathode. As a result, the removal of the target ionic species can be forced to occur predominately at one electrode or the other. The applied voltage will split between the at least one first electrode (for example, an anode) and the at least one second electrode (for example, cathode) according to the electrodes' material properties, such as mass, void ratio, pore size, surface area, and/or resistance.

According to one or more embodiments, an electrochemical device for purifying a target ionic species by at least partially removing or reducing the target ionic species from an aqueous solution using faradaic immobilization includes at least one first electrode that includes an activated carbon film having a void fraction (void ratio) of about 10% to about 75% and a surface area of about 600 square meters per gram to about 2,000 square meters per gram, and at least one second electrode that includes a carbon-based material having a void fraction of about or greater than 95% and a surface area of about 0.1 square meters per gram to about 5 square meters per gram.

### Electrochemical Devices

Electrochemical devices described herein at least partially remove or reduce the target ionic species from the aqueous solution. Non-limiting examples of the target ionic species, e.g., metals, include silver, copper, chromium, lead, manganese, nickel, zinc, chlorine, chloramine, or any combination thereof. In some embodiments, the chromium is Cr (VI) and is reduced to Cr (III).

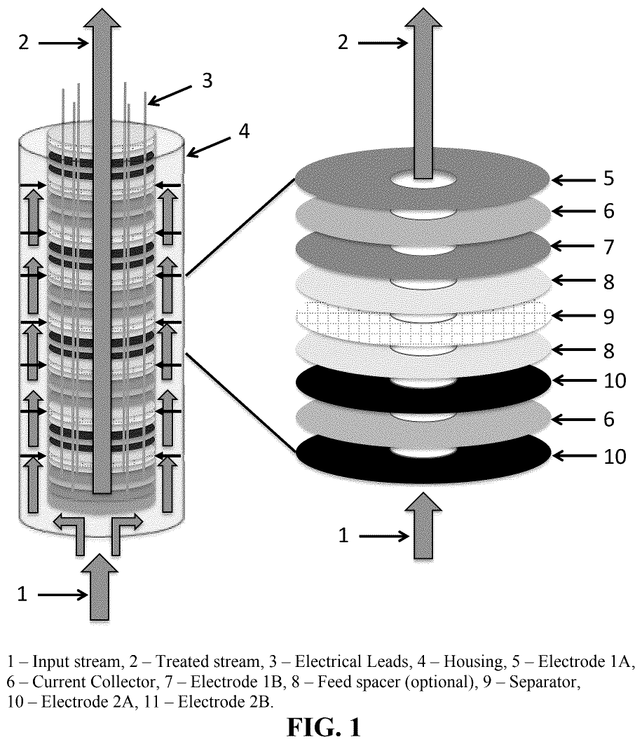

According to other embodiments, the electrochemical device is a stacked device that includes a plurality of the at least one first electrode (5—electrode 1A, 10—electrode 2A in FIG. 1) and a plurality of the at least one second electrode (7—electrode 1B, 11—electrode 2A in FIG. 1). The feed 1 (influent, or input stream) flows in the bottom of the device, proceeds through an annular space near the wall of the cell housing 4, then flows centripetally over the electrode surfaces to the axial channel, and is then discharged as a treated stream 2 (effluent or output stream) through the axial channel to the outlet. Current collectors 6 are attached to the electrodes, usually in multiple locations to reduce electrical losses. Separator 110 is arranged between the carbon-based cathode 112 and the metal-based anode 108. A separator 9 is a dielectric material that prevents physical and electrical contact between the electrodes. Feed spacers 8 are optional; a feed spacer is an additional layer of material between anode and cathode that can optionally be added to create a larger flow channel for the through stream. Electrical contacts 3 (or electrical connections) and associated wiring (not shown) provide the necessary electrical connections to the electrical power supply (not shown).

An input stream of the aqueous stream enters through an inlet in the electrochemical device and is treated to at least partially remove or reduce the content of the one or more target species in the aqueous solution of the input stream, providing a treated output stream with a more reduced content of the target species, which further processed as desired.

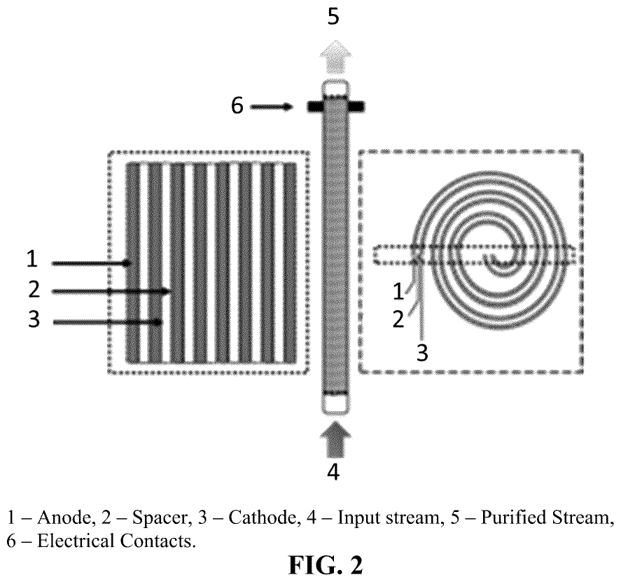

According to one or more embodiments, the electrochemical device is a rolled device, as shown in FIG. 2. A rolled cell design includes a continuous separator (spacer 2) and porous carbon-based electrode materials (1—anode and 3—cathode) that are physically rolled into a spiral to create a cylinder with multiple, predominantly flow-by, through stream paths through the porous carbon electrodes.

The electrochemical device includes an electrode stack that includes at least one first electrode and at least one second electrode (cathodes and anodes) separated by separators, along with current collectors attached to the at least one first electrode and at least one second electrode. The electrode stack is physically rolled into a spiral to create a cylinder with multiple, predominantly flow-by, through stream paths through the porous carbon electrodes. To make a rolled electrochemical device, single continuous sheets of anode material, separator material, and cathode material are stacked and then rolled up to form a cylinder. Current collectors are attached to the anode and the cathode, usually in multiple locations to reduce electrical losses. The input stream flows through, axially, as well as flows-by the rolled electrode stack.

### Electrodes

The electrochemical device includes one or more electrode stacks of at least one first electrode and at least one second electrode. Each of the at least one first electrode and at least one second electrode is a carbon-based material. Non-limiting examples of the carbon-based materials include woven carbon cloths, carbon films, activated carbon materials, non-wovens (e.g. carbon felts), or any combination thereof.

The asymmetry of the electrodes provides a desired voltage distribution across the device, which equates to a different voltage at each electrode, to control the speciation of the target ionic species at the anode and the cathode. As a result, the removal of the target ionic species can be forced to occur predominately at one electrode or the other in some instances. The applied voltage will split between the at least one first electrode (for example, an anode) and the at least one second electrode (for example, cathode) according to the electrodes' material properties, such as mass, area, surface area, resistance, etc.

Voltage is a function of the current and resistance as shown in Equation 1, and current is related to the area to which it is applied:

$$( a ) V = IR and \qquad [ 1 ]$$

$$I = iA \to V = i A R$$

wherein in Equation 1, V is voltage, I is current, R is resistance, i is current density, and A is the cross-sectional area. Therefore, an electrode with a larger area will require less current density to maintain the applied voltage. Likewise, a more resistive electrode will require less current density to maintain the applied voltage.

When there are two electrodes or more involved, the overall voltage can be taken as the sum of the voltage at each electrode and Equation 1 can be expressed as Equation 2,

$$( a ) {V}_{tot} = {I}_{tot} {R}_{tot} \to {V}_{tot} = {I}_{a} {R}_{a} + {I}_{c} {R}_{c} + … \qquad [ 2 ]$$

wherein in Equation 2, the subscript tot is total, a is anode, and c is cathode.

If we consider two electrodes with different surface areas (or mass, area, resistance, etc.), the voltage will split according to the Equation 2. This translates into less voltage at the higher surface area electrode and more voltage at the lower surface area electrode. For example, between the at least one first electrode having a low void fraction (about 10% to about 75%) and high surface area (about 600 square meters per gram to about 2,000 square meters per gram), and the at least one second electrode having a high void fraction (about or greater than 95%) and low surface area (about 0.1 square meters per gram to about 5 square meters per gram), the at least one second electrode would receive more voltage than the at least one first electrode during device operation because it has the lower surface area of the two. In contrast, in embodiments, with the at least one first electrode having a high void fraction (about or greater than 95%) and low surface area (about 0.1 square meters per gram to about 5 square meters per gram), and the at least one second electrode having a high void fraction (about 65% to about 99.9%) and high surface area (about 700 square meters per gram (m²/g) to about 2300 square meters per gram), the at least one first electrode would receive more voltage than the at least one second electrode during device operation because it has the lower surface area of the two.

In one or more embodiments, the at least one first electrode is a carbon film. In some embodiments, the at least one first electrode is an activated carbon film. In other electrodes, the at least one first electrode is a carbon film comprising a binder. In one or more embodiments, the at least one first electrode does not include a binder.

Non-limiting examples of activated carbon films for the at least one first electrode (low void fraction (about 10% to about 75%) and high surface area (about 600 to about 2,000 square meters per gram) include Carbon films 1-6, which include carbon films, carbon films with binders, and activated carbon films (see Table 1 below for carbon properties).

A non-limiting example of a carbon felt for the at least one first electrode (a high void fraction (about or greater than 95%) and low surface area (about 0.1 square meters per gram to about 5 square meters per gram) includes a carbon felt (Carbon felt 1, see Table 1 below for carbon properties).

In some embodiments, the at least one second electrode is a carbon based felt, carbon based woven cloth, or activated carbon nonwoven felt. A non-limiting example of a carbon felt for the at least one second electrode (a high void fraction (about or greater than 95%) and low surface area (about 0.1 square meters per gram to about 5 square meters per gram) includes Carbon felt 1 (see below for carbon properties). A non-limiting example of a woven cloth for the at least one second electrode (high void fraction (about 70% to about 99.9%) and high surface area (about 1200 to about 2300 square meters per gram)) includes Carbon cloth 1 (see below for carbon properties). A non-limiting example of an activated carbon nonwoven felt for the at least one second electrode (high void fraction (about 70% to about 99.9%) and high surface area (about 1200 to about 2300 square meters per gram)) includes Carbon felt 2 (see below for carbon properties). A non-limiting example of a woven cloth for the at least one second electrode (a high void fraction (about 65% to about 99.9%) and low surface area (about 0.1 square meters per gram to about 5 square meters per gram) includes Carbon felt 1 (see below for carbon properties). Non-limiting examples of a woven cloth for the at least one second electrode having a high void fraction (about 65% to about 99.9%) and high surface area (about 700 square meters per gram (m²/g) to about 2300 square meters per gram) include Carbon cloth 2 and Carbon cloth 1 (see below for carbon properties). A non-limiting example of an activated carbon nonwoven felt for the at least one second electrode having a high void fraction (about 65% to about 99.9%) and high surface area (about 700 square meters per gram (m²/g) to about 2300 square meters per gram) includes Carbon felt 2 (see below for carbon properties).

Void ratio describes the open porosity of a carbon material and how easily an aqueous solution can flow through the carbon material. The void ratio (also referred to as void fraction) is a measurement of the amount of aqueous solution (or water) displaced by a piece of carbon material of known dimensions and mass according to the following equation:

$$( a ) Void ratio ( \% ) = \frac{{V}_{carbon} - {V}_{water displaced}}{{V}_{carbon}}$$

where V_{carbon} is the volume of the carbon, V_{water displaced} is the volume of water (or aqueous solution) displaced. The units of V_{carbon} and V_{water displaced} are the same, resulting in a void ratio (%).

Due to differences in void fraction (also referred to as void ratio) of the at least one first and the at least one second electrode, water flows through an electrode with a high porosity (about or greater than 95%, about 65% to about 99.9%, or about 70% to about 99.9% void fraction), while the aqueous solution does not flow through an electrode with a low porosity (about 10% to about 75% void fraction).

In some embodiments, the at least one first electrode with the activated carbon film is microporous and includes a binder. Non-limiting examples of the binder of the activated carbon film include polyvinylidene fluoride (PVDF), polytetrafluoroethylene (PTFE), sodium alginate, sodium-carboxymethyl cellulose, an ion exchange binder or a combination thereof.

In one or more embodiments, the activated carbon film of the at least one first electrode has a void fraction of about 10% to about 75%. Still yet, in other embodiments, the activated carbon film of the at least one first electrode has a void fraction of about or in any range between about 10%, 15%, 20%, 25%, 30%, 35%, 40%, 45%, 50%, 55%, 60%, 65%, 70%, and 75%. In another embodiment, the activated carbon film of the at least one first electrode has a void fraction of about 30% to about 60%, about 10% to about 15%, about 10% to about 70%, about 20% to about 60%, about 30% to about 60%, or about 40% to about 70%, about 60% to about 80%, or about 50% to about 70%.

In some embodiments, the activated carbon film of the at least one first electrode has a surface area of about 600 to about 2,000 square meters per gram. Still yet, in other embodiments, the activated carbon film of the at least one first electrode has a surface area of about or in any range between about 600, 620, 640, 660, 680, 700, 720, 740, 760, 780, 800, 820, 840, 860, 880, 900, 920, 940, 960, 980, 1000, 1020, 1040, 1060, 1080, 1100, 1120, 1140, 1160, 1180, 1200, 1220, 1240, 1260, 1280, 1300, 1320, 1340, 1360, 1380, 1400, 1420, 1440, 1460, 1480, 1500, 1520, 1540, 1560, 1580, 1600, 1620, 1640, 1660, 1680, 1700, 1720, 1740, 1760, 1780, 1800, 1820, 1840, 1860, 1880, 1900, 1920, 1940, 1960, 1980, and 2000 square meters per gram. In other embodiments, the activated carbon film of the at least one first electrode has a surface area of about 600 to about 9000; about 600 to about 1,500; about 800 to about 1,000; about 1,000 to about 2,000; about 1,000 to about 1,500; about 1,800 to about 2,000; about 1,100 to about 1,500; or about 1,200 to about 2,000 square meters per gram. In some embodiments, the at least one first electrode (the negative electrode) is a cathode, and the at least one second electrode (the positive electrode) is an anode. In other embodiments, the at least one first electrode is an anode, and the at least one second electrode is a cathode.

In one or more embodiments, the at least one first electrode that includes an activated carbon film has a density of about 0.2 to about 1.5 grams per cubic centimeter. In other embodiments, the at least one first electrode that includes an activated carbon film has a density of about 1.0 to about 1.5 grams per cubic centimeter. In some embodiments, the at least one first electrode that includes an activated carbon film has a density of about 0.4 to about 0.8 grams per cubic meter. Still in other embodiments, the at least one first electrode that includes an activated carbon film has a density of about 0.5 to about 0.9 grams per cubic meter. In other embodiments, the at least one first electrode that includes an activated carbon film has a density of about a density of about 0.5 to about 0.9 grams per cubic meter. In certain embodiments, the at least one first electrode that includes an activated carbon film has a density about or in any range between about 0.2, 0.3, 0.4, 0.5, 0.6, 0.7, 0.8, 0.9, 1.0, 1.1, 1.2, 1.3, 1.4, and 1.5 grams per cubic meter.

In one or more embodiments, the at least one first electrode that includes an activated carbon film has an areal density of about 100 to about 500 grams per square centimeter. In other embodiments, the at least one first electrode that includes an activated carbon film has a areal density of about 200 to about 500 grams per square centimeter. In some embodiments, the at least one first electrode that includes an activated carbon film has an areal density of about 60 to about 100 grams per cubic meter. Still in other embodiments, the at least one first electrode that includes an activated carbon film has an areal density of about 140 to about 180 grams per square meter. In other embodiments, the at least one first electrode that includes an activated carbon film has a density of about an areal density of about 140 to about 170 grams per square meter. In certain embodiments, the at least one first electrode that includes an activated carbon film has an areal density about or in any range between about 100, 120, 140, 160, 180, 200, 220, 240, 260, 280, 300, 320, 340, 360, 380, 400, 420, 440, 460, 480, and 500 grams per square meter.

In certain embodiments, the activated carbon film has a void fraction of about 10% to about 15%; a surface area of about 800 to about 1,000 square meters per gram; a density of about 1.0 to about 1.5 grams per cubic centimeter; an areal density of about 200 to about 500 grams per square meters; a microporous pore size; or any combination thereof.

In certain embodiments, the activated carbon film has a void fraction of about 60% to about 80%; a surface area of about 1,800 to about 2,000 to square meters per gram; a density of about 0.4 to about 0.8 grams per cubic meter; an areal density of about 60 to about 100 grams per square meter; a microporous pore size; or any combination thereof.

In certain embodiments, the activated carbon film has a void fraction of about 50% to about 70%; a surface area of about 1,100 to about 1,500 square meters per gram; a density of about 0.5 to about 0.9 grams per cubic meter; an areal density of about 140 to about 180 grams per square meter; a microporous pore size; or any combination thereof.

In certain embodiments, the activated carbon film has a void fraction of about 30% to about 60%; a surface area of about 600 to about 900 square meters per gram; a density of about 0.5 to about 0.9 grams per cubic meter; an areal density of about 140 to about 170 grams per square meter; a microporous pore size; or any combination thereof.

In some embodiments, the at least one first electrode that includes the carbon-based material is a carbon felt. In one or more embodiments, the at least one first electrode has a void fraction of about or greater than 95%. In other embodiments, the at least one first electrode has a void fraction of about, greater than, or in any range between about 95%, 96%, 97%, 98%, 99%, and 99.9%, for example about 95% to about 99%, about 95% to about 98%, about 95% to about 97%, and about 95% to about 96%. In some embodiments, the at least one first electrode has a surface area of less than 5 square meters per gram. Still yet, in other embodiments, the at least one first electrode has a surface area of about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram.

In some embodiments, the at least one second electrode that includes the carbon-based material is a carbon felt. In one or more embodiments, the at least one second electrode has a void fraction of about or greater than 95%. In other embodiments, the at least one second electrode has a void fraction of about, greater than, or in any range between about 95%, 96%, 97%, 98%, 99%, and 99.9%, for example about 95% to about 99%, about 95% to about 98%, about 95% to about 97%, and about 95% to about 96%. In some embodiments, the at least one second electrode has a surface area of less than 5 square meters per gram. Still yet, in other embodiments, the at least one second electrode has a surface area of about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram.

In one or more embodiments, the at least one second electrode that includes a carbon-based material has a density of about 0.01 to about 0.2 grams per cubic centimeter. In other embodiments, the at least one second electrode that includes a carbon-based material has a density of about 0.05 to about 0.15 grams per cubic centimeter. In some embodiments, the at least one second electrode that includes a carbon-based material has a density of about 0.7 to about 0.12 grams per cubic meter. Still in other embodiments, the at least one first electrode that includes an activated carbon film has a density of about 0.5 to about 0.9 grams per cubic meter. In other embodiments, the at least one first electrode that includes an activated carbon film has a density of about a density of about 0.5 to about 0.9 grams per cubic meter. In certain embodiments, the at least one first electrode that includes an activated carbon film has a density about or in any range between about 0.2, 0.3, 0.4, 0.5, 0.6, 0.7, 0.8, 0.9, 1.0, 1.1, 1.2, 1.3, 1.4, and 1.5 grams per cubic meter.

In one or more embodiments, the at least one second electrode that includes a carbon-based material has an areal density of about 100 to about 500 grams per square centimeter. In other embodiments, the at least one second electrode that includes a carbon-based material has an areal density of about 200 to about 500 grams per square centimeter. In some embodiments, the at least one second electrode that includes a carbon-based material has an areal density of about 200 to about 300 grams per square meter. In certain embodiments, the at least one second electrode that includes a carbon-based material has an areal density about or in any range between about 100, 120, 140, 160, 180, 200, 220, 240, 260, 280, 300, 320, 340, 360, 380, 400, 420, 440, 460, 480, and 500 grams per square meter.

In certain embodiments, the at least one second electrode comprising the carbon-based material has a void fraction of about 96% to about 99%; a surface area of about 0.1 to about 1 square meters per gram; a density of about 0.01 to about 0.2 grams per cubic meter; an areal density of about 100 to about 400 grams per square meter; a microporous pore size; or any combination thereof.

In other embodiments, the at least one second electrode that includes the carbon-based material is a nonwoven carbon felt or a woven cloth. In one or more embodiments, the at least one second electrode has a void fraction of about 70% to about 99.9%. In other embodiments, the at least one second electrode has a void fraction of about or in any range between about 70%, 72%, 75%, 77%, 80%, 82%, 85%, 87%, 90%, 92%, 95%, 97%, 99%, and 99.9%. In some embodiments, the at least one second electrode has a surface area of about 1200 to about 2300 square meters per gram. Still yet, in other embodiments, the at least one second electrode has a surface area of about or in any range between about 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram.

In some other embodiments, the at least one second electrode that includes the carbon-based material is a nonwoven felt or a woven cloth. In one or more embodiments, the at least one second electrode has a void fraction of about 65% to about 99.9%. In other embodiments, the at least one second electrode has a void fraction of about, or in any range between about 65%, 68%, 70%, 72%, 75%, 78%, 80%, 82%, 85%, 88%, 90%, 92%, 95%, 97%, 99%, and 99.9%. In some embodiments, the activated carbon film of the at least one second electrode has a surface area of about 700 to about 2300 square meters per gram. Still yet, in other embodiments, the activated carbon film of the at least one second electrode has a surface area of about or in any range between about 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram.

The at least one first and the at least one second electrode are asymmetric. In one or more embodiments with the at least one first electrode having a low void fraction (about 30% to about 65%) and a high surface area (about 1200 square meters per gram (m²/g) to about 1400 square meters per gram). In contrast, the at least one second electrode has either 1) a high void fraction (about or greater than 95%) and a low surface area (about 0.1 square meters per gram to about 5 square meters per gram), or 2) a high void fraction (about 70% to about 99.9%) and a high surface area (about 1200 to about 2300 square meters per gram). While in some other embodiments with the at least one first electrode having a high void fraction (about or greater than 95%) and a low surface area (about 0.1 square meters per gram to about 5 square meters per gram), the at least one second electrode has a high void fraction (about 65% to about 99.9%) and a high surface area (about 700 to about 2300 square meters per gram).

In some embodiments, the carbon materials of each of the at least one first electrode and at least one second electrode are used as single layer materials. In other embodiments, the carbon materials of each of the at least one first electrode and at least one second electrode are used as a plurality of layers in order to increase the mass. For example, in some embodiments, the carbon materials of each of the at least one first electrode and at least one second electrode are used 1, 2, 3, 4, 5, 6, 7, 8, 9, 10, 11, 12, 13, 14, 15 layers.

### Separator

In one or more embodiments, the electrode stacks further include a separator arranged between the at least one first electrode and the at least one second electrode. The separator is a dielectric material and prevents physical and electrical contact between the electrodes. Non-limiting examples of dielectric materials for the separator include cellulosic-based materials, silica-based materials, or any combination thereof.

In embodiments, the separator is a planar structure with a thickness of about 1 to about 5000 micrometers. In some embodiments, the separator has a thickness of about 50 to about 250 micrometers. In other embodiments, the separator has a thickness about, less than or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and about 5000 micrometers.

The thickness of the separator that separates the electrodes defines the separation distance between the electrodes. The separation distance between the stacked, or parallel arranged, electrodes is critical. The electrodes must be close enough to support viable separation. If the electrodes are too far apart, separation is not viable. Removal rate is directly proportional to the separator distance with larger distances leading to greater resistance. With separator distances greater than 1000 microns, the removal rate continues to drop precipitously, increasing the voltage required for operation and the likelihood for water splitting to occur, hurting the efficiency of the process. At distances of less than 1 micron, while the reaction rate may be high, the possibility for short circuiting of the cell due to metal deposits connecting between the anode and the cathode, often referred to as dendrites, becomes quite high. Therefore, for practical operation where both high removal rates can be achieved along with reliable operation, a distance of 1 to 5000 microns is critical. Thus, the separation distance between the at least one first electrode and at least one second electrode is about 1 to about 1000 micrometers, as described above, in some embodiments. In other embodiments, the separation distance between the at least one first electrode and at least one second electrode is about or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and abou5000 micrometers.

### Methods

Some species of a target species will adsorb by physical entrapment (“physical adsorption”) on, or by electrical attraction (“capacitive adsorption”) to, an electrode. Other species of a target species are starting materials for reactions (typically, oxidation) that create, directly or indirectly, new species of the target species that are immobilized on an electrode. Immobilization removes the target species from the solution. At a given spacing between the electrodes and matched carbon electrode materials properties, the potential applied to the anode and cathode are selected, based on the Pourbaix diagram of the target species in the input stream.

Using the Pourbaix diagram for a material can define the pH and voltage needed in the cell to remove or reduce a target species of interest. An aqueous input stream to be purified is introduced into an electrochemical device through an inlet to the cell; the electrodes are immersed in the aqueous stream and a target species is removed or reduced from the through stream. After removal or reduction of a target species, the through stream is discharged from the cell through an outlet for use, storage, or further processing. The electrodes of the cell are connected to a power supply that can apply E+ or E− to a given electrode. The E+ applied to the cell anodes and E− to cell cathodes, electrode materials, and selected Pourbaix operating region are precisely matched to improve purification efficiency and improving cost/benefit. A Pourbaix diagram operating region shows speciation based on applied E and pH. Speciation is driven by the potentials, E+ and E−, applied to the electrodes. Maintaining cell operation in the selected Pourbaix operating region, with optimized electrode materials, increases removal or reduction of the target species far beyond conventional adsorption that occurs with non-asymmetric electrode materials.

Embodiments herein combine adsorption (physical and capacitive) of target species (e.g., lead, iron, manganese, cadmium, chromium, etc.) and immobilization (aka coagulation) of the adsorbed target species by optimizing electrode porosity, applied E, and Pourbaix operating region. The optimization of (i) physical adsorption; (ii) capacitive adsorption; (iii) electrochemical pH modulation & target species immobilization; (iv) electrochemical peroxide (H₂O₂) generation; (v) electrodeposition (e.g., electroplating, electrophoretic deposition); (vi) electrochemical oxidation or reduction; (vii) precipitation; (viii) pore mouth diameter profile; (ix) electrode treatment, (x) electrode spacing, and (xi) flow-by vs. flow-through cell design, depends upon target species, input stream water chemistry, and through stream water chemistry.

Reduction only occurs at the cathode. Electrochemical reduction is usually described as an applied potential to the cell. The voltage distribution between anode and cathode occurs spontaneously based on the amount of applied voltage, the material properties of the electrodes, and the chemistry of the aqueous solution.

Target species, if ionized, bearing an electrical charge, or bearing a partial charge due to the asymmetric distribution of electrons in chemical bonds, can be attracted to the carbon electrode due to the applied potential, which produces a driving force to move the target species close to (or in contact with) the carbon electrode. Non-ions and non-charged species of a target species can collide with an electrode surface. Once in contact with the electrode surface, numerous pathways to immobilization of the target species can occur. Local and large pH swings can be controlled to electrochemically produce an alkaline environment, which will produce, e.g., insoluble metal oxides, that precipitate near or on the electrodes and are entrapped in electrode pores. Faradic reactions, such as oxygen reduction reactions at the cathode, can produce hydrogen peroxide which can diffuse away from the electrode and oxidize target metal molecules that are within close proximity: hydrogen peroxide performs indiscriminate oxidation. When target species closer to the electrode are in a localized higher concentration, the statistical chance for hydrogen peroxide to oxidize the target species is greater. Other faradic reactions, such as direct electron transfer (reduction or oxidation) between the target species and electrode can also occur. Once the target species has been attracted to the electrode surface, the carbon electrode can (1) transfer an electron(s) from the electrode to the target species and reduce it so that it is deposited onto the electrode or (2) transfer an electron(s) from the target species to the carbon electrode and oxidize the target species into either an insoluble oxide or hydroxide, or into a more reactive species that can be immobilized through additional electron transfer reactions or pH adjustments. Precipitated species and electrically attracted species are entrapped in electrode pores.

Analysis of a typical input stream feeding a given device permits adjustments to optimize operating parameters for specific water chemistries (adjustments are to optimize physical and electrochemical adsorption of lead, pH modulations, and oxidation to oxides and other insoluble species). Typical operating parameters are adjusted as follows.

To obtain the potential distribution, a three-electrode set-up is used with a cathode, anode, and a standard calomel electrode (SCE) as the reference. The potential at each electrode is recorded at open circuit, short-circuit, and up to a voltage of 1.4 V with 0.2 V increments. The pH and operating voltage are correlated through the Pourbaix diagram. Based on the pH and potential distributions at each electrode, the speciation can be controlled by selecting what voltage to apply. This calibration process determines and controls what species precipitate at what voltage and in a given input stream water chemistry.

When an output stream metal concentration equals or exceeds the threshold level, rather than replacing the cartridge, some types of can be regenerated. One method of regeneration is by flushing acid through the cell to dissolve coagulated metals and regenerate the electrodes. During this “acid regeneration” step, the output stream is diverted to a receptacle in which the highly concentrated waste stream is collected for other processing. After an acid regeneration step, the cartridge is flushed with water until the output stream reaches pH 7 (or other target pH) before normal operation (i.e., removal of metal ions and particles from the through stream) is resumed. Another method of regeneration is by electrolysis or electrochemical regeneration in an acidic solution; electrolysis (aka electrochemical) regeneration converts metal oxides to soluble metal ions, which are then flushed out of the cartridge with water and collected in a waste receptacle. Electrolysis is an electrochemical reaction that requires the application of an external voltage to drive a reaction that is non-spontaneous. Any insoluble metal species that have formed on the electrodes can be dissolved into solution using a small voltage, typically up to 5 V, applied across the cartridge. Regeneration can also be a sequence of acid regeneration followed by electrolysis, or vice versa.

Multiple devices, in series, each of which targets the same or a different species, can be combined. Multiple devices connected in series (outlet to inlet) tuned to remove the same target species act to successively reduce the concentration of the target species in a single pass of an input stream through the devices connected in series (accomplishing the same level of target species removal as operating a single cell in batch mode multiple times). Adjustment of parameters, e.g., pH of the through stream and voltage applied to the cell electrodes of a given cell, of multiple cells connected in series to different parameters, as the case may be, enable each cell in a series to remove a different target species from the through stream in a single pass. Pourbaix diagrams, which show the speciation of a target species at a given voltage and pH, best illustrate the “cell series” concept.

Applied voltage and electrochemical pH modulation are selected to remove target species from influent using the Pourbaix diagrams. Those of skill in the art can select an applied voltage and electrochemical pH modulation to remove a given species of a target element or complex.

System parameters are monitored and controlled using a computer system that monitors and/or controls various sensors, interfaces, valves, and peripheral equipment, and is commonly known as a process control computer (aka process controller), a computer generally associated with continuous or semi-continuous production operations involving materials such as chemicals and petroleum, whether in liquid, solid, or gas phases. The process control computer enables parameters to be applied to one or more devices in a system and changes in through-stream routing, e.g., changes that convert a series system architecture to a series-parallel system architecture.

In addition to Pb, Ni, Zn, Al, Cu, Fe, Mn, CI, Br, and chloramine, the parameters, and the system and methods disclosed above, can be applied to remove a metal and halide species identified in the Pourbaix diagrams for As, Se, Sc, Ti, V, Cr, Co, Y, Zr, Nb, Mo, Tc, Ru, Rh, Pd, Ag, Cd, La, Hf, Ta, W, Re, Os, Ir, Pt, Au, Hg, Ce, Pr, Nd, Pm, Sm, Eu, Gd, Tb, Dy, Ho, Er, Tm, Yb, Lu, and other halides.

### EXAMPLES

Table 1 shows properties of the various carbon materials. The open porosity/void fraction and specific surface area of each electrode are important for maintaining passing charge and are directly related to the lifetime of the electrodes. When the device is operated and a voltage is applied, the cathode gains electrons and is reduced, while the anode loses electrons and is oxidized. As the anode becomes more oxidized, the pores collapse, effectively reducing its specific surface area, and the amount of charge it can pass. Eventually, the anode may completely lose all capacity to hold a charge; the device may drop in performance and ultimately may stop functioning for its intended purpose.

TABLE 1
Properties of carbon materials

| | | | | | | Specific | |
|---|---|---|---|---|---|---|---|
| | | | Areal | | Void | surface | |
| Carbon-based | Carbon | Density | density | Resistivity | ratio | area | Pore size* |
| electrode | type | (g/cm³) | (g/m²) | (Ω*cm) | (%) | (m²/g) | (nm) |
| Carbon film 1 | Carbon | 0.4 | 151 | 1.29 | 59 | ~1400 | <2 |
| | film with | | | | | | (microporous) |
| | binder | | | | | | |
| Carbon film 2 | Carbon | 0.59 | 182.11 | <1 | 32 | >1200 | <2 |
| | film | | | | | | (microporous) |
| Carbon felt 1 | Carbon | 0.09 | 250 | <0.5 | 97 | 0.4 | <2 |
| | felt | | | | | | (microporous) |
| Carbon cloth 1 | Woven | 0.25 | 135 | 0.8 | 71 | >1800 | <2 |
| | carbon | | | | | | (microporous) |
| | cloth | | | | | | |
| Carbon felt 2 | Activated | 0.051 | 175 | 2.26 | 98 | 1200 | <2 |
| | carbon | | | | | | (microporous) |
| | nonwoven | | | | | | |
| | felt | | | | | | |
| Carbon cloth 2 | Woven | 0.26 | 150.56 | 5 | 66 | ~700 | 2-5 nm |
| | carbon | | | | | | (mesoporous) |
| | cloth | | | | | | |
| Carbon film 3 | Activated | 1.280 | 320 | | 12 | 1086.16 | 1.62 |
| | carbon | | | | | | (microporous) |
| | film | | | | | | |
| Carbon film 4 | Activated | 0.558 | 78.12 | | 69 | 1934.09 | 1.39 |
| | carbon | | | | | | (microporous) |
| | film | | | | | | |
| Carbon film 5 | Activated | 0.703 | 154.66 | | 60 | 1327.10 | 1.67 |
| | carbon | | | | | | (microporous( |
| | film | | | | | | |
| Carbon film 6 | Activated | 0.830 | 199.2 | | 44 | 724.64 | 1.70 |
| | carbon | | | | | | (microporous) |
| | film | | | | | | |

*pore size obtained from the adsorption branch of the isotherm

Table 2 shows the results of specific silver removal from water. The electrodes used in this study were Carbon cloth 1 (cathode) and Carbon felt 1 (anode) using an applied potential of 1.2 volt (V). The electrodes were selected to keep the cathode potential from entering a Cu²⁺ reduction region, which would happen if the electrodes chosen were Carbon felt 1 (cathode) and Carbon film 1 1 (anode). An analysis on the raw and treated product waters are shown in Table 49. Silver was removed selectively from a highly concentrated copper sulfate solution (starting concentration of 69.2 g/L). While the Cu concentration was relatively unchanged around 69 grams per liter (g/L), the Ag concentration was reduced from either 0.07 milligrams per liter (mg/L) or 0.58 mg/L to <0.05 mg/L, demonstrating the selectivity of removal.

TABLE 2
Analysis on the raw and treated product waters for selective silver (Ag) removal

| | | | Treated | | | | Treated 0.5 PPM | |
|---|---|---|---|---|---|---|---|---|
| | Raw water | | product waste | | 0.5 PPM | | spike w Ag | |
| | As | | Through | | spike | | Through | |
| Description | Received | | ElectraMet | | With Ag | | ElectraMet | |
| Ag | 0.07 | mg/L | <0.05 | mg/L | 0.58 | mg/L | <0.05 | mg/L |
| Co | <0.03 | | <0.03 | mg/L | <0.03 | mg/L | <0.03 | mg/L |
| Cr | <0.05 | mg/L | <0.05 | mg/L | <0.05 | mg/L | 0.05 | mg/L |
| Cu | 69.2 | G/L | 69.4 | G/L | 69.3 | G/L | 68.9 | G/L |
| Mn | <0.050 | mg/L | <0.050 | mg/L | <0.050 | mg/L | <0.050 | mg/L |
| Ni | <0.05 | mg/L | <0.05 | mg/L | <0.05 | mg/L | <0.05 | mg/L |
| Sn | <0.20 | mg/L | <0.20 | mg/L | <0.20 | mg/L | <0.20 | mg/L |

| | | | | |
|---|---|---|---|---|
| pH | 2.69 | 2.69 | 2.69 | 2.66 |
| Specific Gravity | 1.1665 | 1.687 | 1.1685 | 1.1673 |

Cu²⁺ removal was examined using cartridges operating at 1.2 V with Cu spiked into tap water; the results are shown in Table 3. Both porous carbon cathodes and porous carbon anodes were used. When a high surface area microporous carbon cathode (Carbon cloth 1) and a mesoporous carbon anode (Carbon cloth 2) were used, approximately 60% removal was found. When a low surface area porous carbon cathode (Carbon felt 1) was combined with a dense carbon anode (Carbon film 2), >99% removal was found, the highest of these separations. When a low surface area carbon cathode (Carbon felt 1) was combined with a mesoporous carbon anode (Carbon cloth 2), the lowest removal was found of ˜27%. These results show that copper removal is highest with a low surface area carbon felt cathode was combined with a dense carbon film anode.

TABLE 3
Copper removal with asymmetric electrodes

| | | | Cu | Cu | Cu | |
|---|---|---|---|---|---|---|
| | | Voltage/ | Feed/ | Effluent/ | Removed/ | Removal |
| Cathode | Anode | V | ppm | ppm | ppm | % |
| Carbon | Carbon | 1.2 | 0.54 | 0.215 | 0.325 | 60.19% |
| cloth 1 | cloth 2 | | | | | |
| Carbon | Carbon | 1.2 | 0.54 | 0.391 | 0.149 | 27.59% |
| felt 1 | cloth 2 | | | | | |
| Carbon | Carbon | 1.2 | 0.54 | 0.005 | 0.535 | 99.07% |
| felt 1 | film 2 | | | | | |

Provided the 99.07% removal with the combination of a low surface area carbon felt cathode with a dense carbon film anode with a surface area of >1200 m²/g, carbon films with lower and higher surface areas were analyzed to determine whether such combination results in favorable copper removal. Tables 4 illustrates copper (Cu) removal from a feed stream with the activated carbon films in Table 1 (Carbon film 4, Carbon film 5, and Carbon film 6) used as the anode, together with a low surface area carbon felt cathode—Carbon felt 1 with a surface area of 0.4 m²/g and void ratio of 97%. Carbon film 4 activated carbon film anodes were used as single (1×) and double (2×) layers to increase the mass of the anode. Carbon film 5 activated carbon film anodes were used as single (1×) and five (5×) layers. Carbon film 6 activated carbon films were used as single layers. The Carbon film 3 activated carbon films were used as 7 (7×) layers. 1.2 V was applied to asymmetric cartridges with Cu spiked into tap water.

All activated carbon films (Carbon film 5, Carbon film 4, and Carbon film 6) produced favorable removal, ranging from 61.6% to 93.1%. For each of Carbon film 4 and Carbon film 5, adding additional layers to increase the anode mass significantly increased copper removal. A single layer of Carbon film 4 resulted in 61.6% removal versus a double layer with 70.1%. Similarly, a single layer of Carbon film 5 provided 58.1% removal, while 5× layers resulted in 93.1% removal. 7× layers of the Carbon film 3 likewise increased removal to 84.3%.

These results demonstrate that moderately higher surface area (compared to >1200 m²/g) activated carbon films (with surface areas of 1327 m²/g (Carbon film 5) and 1934 m²/g (Carbon film 4)) also effectively removed copper when combined with a low surface area carbon felt cathode. Further, even a lower surface area activated carbon film (Carbon film 6, 725 m²/g) effectively removed copper. These results indicate that optimal removal can be obtained across a broader range of carbon surface areas than previously anticipated.

TABLE 4
Activated carbon film cathodes with a wide range of surface
areas combined with a lower surface area carbon felt cathode

| | | [Cu] | [Cu] | | |
|---|---|---|---|---|---|
| | | in feed | effluent | Removal | Charge |
| Cathode | Anode | (ppm) | (ppm) | % | (C) |
| Carbon felt 1 | 1X Carbon | 100 | 38.4 | 61.6% | 356.68 |
| | film 4 | | | | |
| Carbon felt 1 | 2X Carbon | 101 | 28.8 | 70.1% | 200.4 |
| | film 4 | | | | |
| Carbon felt 1 | 1X Carbon | 101 | 42.3 | 58.1% | 191.01 |
| | film 5 | | | | |
| Carbon felt 1 | 5X Carbon | 101 | 6.94 | 93.1% | 247.33 |
| | film 5 | | | | |
| Carbon felt 1 | 1X Carbon | 99.4 | 27.8 | 72.0% | 251.48 |
| | film 6 | | | | |
| Carbon felt 1 | 7X Carbon | 99.4 | 15.6 | 84.3% | 245.84 |
| | film 3 | | | | |

The activated carbon film (Carbon film 3) anode and microporous carbon felt cathode also demonstrated the ability to selectively recover other precious metals, gold (Au), palladium (Pd), platinum (Pt), and silver (Ag), as shown in Table 5. Au, Pd, and Pt were selectively removed with recoveries of 99.1%, 99.7%, and 88.0%, respectively.

TABLE 5
Activated carbon film anode and carbon felt
cathode selectively remove other metals

| Metal | [M] in feed | [M] in effluent | Removal |
|---|---|---|---|
| (M) | (ppm) | (ppm) | % |
| Au | 23 | 0.2 | 99.1% |
| Pd | 15 | 0.05 | 99.7% |
| Pt | 2.5 | 0.3 | 88.0% |

Cr(VI) reduction is also preferentially carried out in a Carbon felt 1 (cathode)/Carbon film 1 (anode) cartridge over Cu²⁺ reduction, when present as well as at voltages of 1.2 V and below. In an industrial wastewater sample, the reduction of both Cr(VI) and Cu²⁺ was examined. The starting concentration of Cr(VI) was 115 mg/L while the starting concentration of Cu was 135 mg/L. As shown in Table 6, reduction was evaluated using the cartridge mentioned herein containing a Carbon felt 1 cathode and Carbon film 1 anode at applied voltages of 0.4, 0.6, 0.8, 1.0, and 1.2 V. Effluent concentrations from the cartridges were examined using Cr(VI) test strips as well as ICP-MS. Reduction of Cr(VI) is evident at cell voltages as low as 0.6 V, while no Cu removal is seen. As the cell voltage is increased towards 1.2 V, Cr(VI) reduction increases.

TABLE 6
Hexavalent chromium (Cr(VI)) reduction to trivalent
chromium (Cr(III)) with asymmetric electrodes

| | Concentration/mg L⁻¹ | |
|---|---|---|
| Description | Cr | Cu |
| Raw Feed Water | 115.00 | 135.00 |
| Feed to Cartridge | >50 | 143.00 |
| After 0.4 V Cartridge | >50 | 146.00 |
| After 0.6 V Cartridge | 25.00 | 148.00 |
| After 0.8 V Cartridge | 10.00 | 157.00 |
| After 1.0 V Cartridge | 5.00 | 131.00 |
| After 1.2 V Cartridge | 2.50 | 137.00 |
| After 1.2 V Cartridge, pH 8, Filtered 1.5 μm | 0.292 | 3.59 |

Table 7 shows the results of removing lead using asymmetric carbon electrodes. Cathode/anode combinations included Carbon cloth 1/Carbon felt 1, Carbon cloth 1/Carbon cloth 2, and Carbon felt 2/Carbon cloth 1. As shown, the Carbon cloth 1 cathode/Carbon felt 1 anode combination resulted in 94.98% lead removal.

TABLE 7
Lead removal with asymmetric electrodes

| | | | Pb | Pb | Pb | |
|---|---|---|---|---|---|---|
| | | Voltage/ | Feed/ | Effluent/ | Removed/ | Removal |
| Cathode | Anode | V | ppm | ppm | ppm | % |
| Carbon | Carbon | 1.2 | 2.29 | 0.115 | 2.175 | 94.98% |
| cloth 1 | felt 1 | | | | | |
| Carbon | Carbon | 1.2 | 2.87 | 0.513 | 2.357 | 82.13% |
| cloth 1 | cloth 2 | | | | | |
| Carbon | Carbon | 1.2 | 2.88 | 0.679 | 2.201 | 76.42% |
| felt 2 | cloth 1 | | | | | |

Manganese removal from ground water and spiked tap water was examined at concentrations <1 ppm. Shown in Table 8 are the results of separation testing using Carbon film 2 (cathode)/Carbon felt 1 (anode) as well as one test using a Carbon felt 1 (cathode)/Carbon film 2 (anode). The operating voltage was 1.0 V in all instances in Table 7. As shown in Table 7, when a porous carbon anode (Carbon felt 1) and dense carbon cathode (Carbon film 2) were used, >95% Mn removal was achieved in all cases. When a dense carbon anode (Carbon film 2) and porous carbon cathode (Carbon felt 1) were used, Mn removal dropped to <5%, demonstrating the importance of flow path and carbon implementation on removal.

TABLE 8
Manganese (Mn) removal with asymmetric electrodes

| | | | Mn | Mn | Mn | |
|---|---|---|---|---|---|---|
| | | Voltage/ | Feed/ | Effluent/ | Removed/ | Removal |
| Anode | Cathode | V | ppm | ppm | ppm | % |
| Carbon | Carbon | 1 | 0.293 | 0.283 | 0.01 | 3% |
| film 2 | felt 1 | | | | | |
| Carbon | Carbon | 1 | 0.293 | 0.011 | 0.282 | 96% |
| felt 1 | film 2 | | | | | |
| Carbon | Carbon | 1 | 0.291 | 0.016 | 0.275 | 95% |
| felt 1 | film 2 | | | | | |
| Carbon | Carbon | 1 | 0.291 | 0.006 | 0.285 | 98% |
| felt 1 | film 2 | | | | | |
| Carbon | Carbon | 1 | 0.303 | 0.008 | 0.295 | 97% |
| felt 1 | film 2 | | | | | |
| Carbon | Carbon | 1 | 0.298 | 0.009 | 0.289 | 97% |
| felt 1 | film 2 | | | | | |
| Carbon | Carbon | 1 | 0.298 | 0.005 | 0.293 | 98% |
| felt 1 | film 2 | | | | | |
| Carbon | Carbon | 1 | 0.298 | 0.005 | 0.293 | 98% |
| felt 1 | film 2 | | | | | |
| Carbon | Carbon | 1 | 0.28 | 0.006 | 0.274 | 98% |
| felt 1 | film 2 | | | | | |
| Carbon | Carbon | 1 | 0.284 | 0.007 | 0.277 | 98% |
| felt 1 | film 2 | | | | | |
| Carbon | Carbon | 1 | 0.288 | 0.01 | 0.278 | 97% |
| felt 1 | film 2 | | | | | |

In addition to the spiked tap water studies shown in Table 8, Mn removal from groundwater was also examined as shown in Table 9. In this case, three different Cartridge types were examined for the removal of Mn from a raw groundwater stream: (1) Carbon cloth 1 (cathode)/Carbon felt 1 (anode) showed 80-90% Mn removal; (2) Carbon film 1 (cathode)/Carbon felt 1 (anode) showed >99% Mn removal; Carbon felt 1 (cathode)/Carbon film 1 (anode) showed <20% Mn removal. Cell voltages of 0.8-1.5 V were used.

TABLE 9
Manganese (Mn) removal from a raw groundwater stream

| | | Volt- | Mn | Mn | Mn | |
|---|---|---|---|---|---|---|
| | | age/ | Feed/ | Effluent/ | Removed/ | Removal |
| Anode | Cathode | V | ppm | ppm | ppm | % |
| Carbon | Carbon | 1.2 | 0.276 | 0.08 | 0.196 | 71% |
| cloth 1 | felt 1 | | | | | |
| Carbon | Carbon | 1.2 | 0.276 | 0.066 | 0.21 | 76% |
| cloth 1 | felt 1 | | | | | |
| Carbon | Carbon | 1.2 | 0.276 | 0.047 | 0.229 | 83% |
| cloth 1 | felt 1 | | | | | |
| Carbon | Carbon | 1.5 | 0.276 | 0.06 | 0.216 | 78% |
| cloth 1 | felt 1 | | | | | |
| Carbon | Carbon | 1.5 | 0.276 | 0.077 | 0.199 | 72% |
| cloth 1 | felt 1 | | | | | |
| Carbon | Carbon | 1.5 | 0.276 | 0.058 | 0.218 | 79% |
| cloth 1 | felt 1 | | | | | |
| Carbon | Carbon | 1 | 0.276 | 0.049 | 0.227 | 82% |
| cloth 1 | felt 1 | | | | | |
| Carbon | Carbon | 1 | 0.276 | 0.052 | 0.224 | 81% |
| cloth 1 | felt 1 | | | | | |
| Carbon | Carbon | 1 | 0.276 | 0.055 | 0.221 | 80% |
| cloth 1 | felt 1 | | | | | |
| Carbon | Carbon | 0.8 | 0.276 | 0.05 | 0.226 | 82% |
| cloth 1 | felt 1 | | | | | |
| Carbon | Carbon | 1.2 | 0.253 | 0 | 0.253 | 100% |
| film 2 | felt 1 | | | | | |
| Carbon | Carbon | 1.2 | 0.253 | 0 | 0.253 | 100% |
| film | felt 1 | | | | | |
| 2Carbon | | | | | | |
| film 2 | | | | | | |
| Carbon | Carbon | 1 | 0.253 | 0 | 0.253 | 100% |
| film 2 | felt 1 | | | | | |
| Carbon | Carbon | 1 | 0.253 | 0 | 0.253 | 100% |
| film 2 | felt 1 | | | | | |
| Carbon | Carbon | 1.2 | 0.253 | 0.213 | 0.04 | 16% |
| felt 1 | film 2 | | | | | |

Nickel removal was examined using cartridges built using a variety of porous carbon electrodes showing varying degrees of removal from Ni-spiked tap water. As shown in Table 10, the best removal achieved was with a low surface area porous carbon cathode (Carbon felt 1) and a mesoporous carbon anode (Carbon cloth 2) at 2.0 V, where nearly 80% of Ni was removed.

TABLE 10
Nickel removal with asymmetric electrodes

| | | | Ni | Ni | Ni | |
|---|---|---|---|---|---|---|
| | | Voltage/ | Feed/ | Effluent/ | Removed/ | Removal |
| Cathode | Anode | V | ppm | ppm | ppm | % |
| Carbon | Carbon | 1.2 | 8.84 | 7.34 | 1.5 | 16.97% |
| cloth 1 | cloth 2 | | | | | |
| | | 1.6 | 8.84 | 7.25 | 1.59 | 17.99% |
| | | 2 | 8.84 | 6.48 | 2.36 | 26.70% |
| Carbon | Carbon | 1.2 | 4.88 | 3.73 | 1.15 | 23.57% |
| felt 1 | cloth 2 | | | | | |
| | | 1.6 | 4.88 | 2.5 | 2.38 | 48.77% |
| | | 2 | 4.88 | 1.03 | 3.85 | 78.89% |
| Carbon | Carbon | 2.5 | 4.88 | 2.86 | 2.02 | 41.39% |
| cloth 2 | felt 1 | | | | | |

Zinc removal was examined using cartridges built using a variety of porous and dense carbon electrodes showing varying degrees of removal from Zn-spiked tap water, as shown in Table 11 When a porous carbon cathode (Carbon cloth 1, Carbon felt 2, Carbon felt 1) was combined with a dense carbon anode (Carbon film 2), the best results were achieved. Using cell voltages of 1.5-2.5 V, up to 95% removal of Zn was found. When a dense carbon cathode was combined with a porous carbon anode, the best removal was achieved at 2.5 V of approximately 65%. At lower cell voltages, the overall percent removal of Zn was much lower, between 22-55% removal.

TABLE 11
Zn removal with asymmetric electrodes

| | | | Zn | Zn | Zn | |
|---|---|---|---|---|---|---|
| | | Voltage/ | Feed/ | Effluent/ | Removed/ | Removal |
| Cathode | Anode | V | ppm | ppm | ppm | % |
| Carbon | Carbon | 1.5 | 12.2 | 0.6 | 11.6 | 95.08% |
| cloth 1 | film 2 | | | | | |
| | | 2 | 12.2 | 1.96 | 10.24 | 83.93% |
| | | 2.5 | 12.2 | 0.56 | 11.64 | 95.41% |
| Carbon | Carbon | 1.5 | 12.2 | 9.4 | 2.8 | 22.95% |
| film 2 | cloth 1 | | | | | |
| | | 2 | 12.2 | 5.6 | 6.6 | 54.10% |
| | | 2.5 | 12.2 | 4.2 | 8 | 65.57% |
| Carbon | Carbon | 1.5 | 2.23 | 0.15 | 2.08 | 93.27% |
| felt 2 | film 2 | | | | | |
| | | 2 | 2.23 | 0.12 | 2.11 | 94.62% |
| | | 2.5 | 2.23 | 0.08 | 2.15 | 96.41% |
| Carbon | Carbon | 1.5 | 10.2 | 7.52 | 2.68 | 26.27% |
| film 2 | felt 1 | | | | | |
| | | 2 | 10.2 | 7.6 | 2.6 | 25.49% |
| | | 2.5 | 10.2 | 7.48 | 2.72 | 26.67% |
| Carbon | Carbon | 1.5 | 10.2 | 2.06 | 8.14 | 79.80% |
| felt 1 | film 2 | | | | | |
| | | 2 | 10.2 | 1.62 | 8.58 | 84.12% |
| | | 2.5 | 10.2 | 0.68 | 9.52 | 93.33% |

Chlorine/chloramine removal was carried out with cathode/anodes of Carbon felt 1/Carbon film 2, Carbon cloth 1/Carbon film 2, Carbon cloth 1/Carbon felt 1, Carbon felt 2/Carbon film 2, and Carbon felt 2/2× Carbon film 2 (wherein 2× means 2 layers of Carbon film 2 were stacked to increase the mass of the anode). Table 12 shows the testing results that were carried out with a Carbon felt 2 cathode and 2× Carbon film 2 anode. In Table 11, the feed is the starting concentrations, the product is after purification, and the removal is the % removed. Average feed total chlorine was 2.73 parts per million (ppm). The average product free chlorine concentration was 0.01 ppm with an average product chloramine concentration of 0.12 ppm.

TABLE 12
Chlorine/chloramine removal with asymmetric electrodes

| Feed | | | Product | | | Removal | | |
|---|---|---|---|---|---|---|---|---|
| Total Cl | Free Cl | Chloramine | Total Cl | Free Cl | Chloramine | Total Cl | Free Cl | Chloramine |
| (ppm) | (ppm) | (ppm) | (ppm) | (ppm) | (ppm) | (ppm) | (ppm) | (ppm) |
| 2.46 | 0.30 | 2.16 | 0.24 | 0 | 0.24 | 90% | 100% | 89% |
| 2.73 | 0.66 | 2.07 | 0.2 | 0 | 0.2 | 93% | 100% | 90% |
| 2.45 | 0.82 | 1.63 | 0.18 | 0 | 0.18 | 93% | 100% | 89% |
| 2.31 | 1.97 | 0.34 | 0.12 | 0 | 0.12 | 95% | 100% | 65% |
| 2.67 | 0.48 | 2.19 | 0.19 | 0 | 0.19 | 93% | 100% | 91% |
| 2.88 | 0.36 | 2.52 | 0.19 | 0 | 0.19 | 93% | 100% | 92% |
| 2.72 | 0.51 | 2.21 | 0.21 | 0 | 0.21 | 92% | 100% | 90% |
| 2.54 | 0.51 | 2.03 | 0.16 | 0.15 | 0.01 | 94% | 71% | 100% |
| 2.71 | 0.32 | 2.39 | 0.77 | 0.04 | 0.73 | 72% | 88% | 69% |
| 2.59 | 1.61 | 0.98 | 0.78 | 0.34 | 0.44 | 70% | 79% | 55% |
| 2.49 | 0.30 | 2.19 | 0.83 | 0.36 | 0.47 | 67% | −20% | 79% |
| 2.49 | 0.30 | 2.19 | 0.65 | 0.32 | 0.33 | 74% | −7% | 85% |
| 2.64 | 0.89 | 1.75 | 0.16 | 0 | 0.16 | 94% | 100% | 91% |
| 2.64 | 0.89 | 1.75 | 0.18 | 0 | 0.18 | 93% | 100% | 90% |
| 2.84 | 2.26 | 0.58 | 0.61 | 0.12 | 0.49 | 79% | 95% | 16% |
| 2.84 | 2.26 | 0.58 | 0.14 | 0.03 | 0.11 | 95% | 99% | 81% |
| 2.66 | 2.50 | 0.16 | 0.12 | 0 | 0.12 | 95% | 100% | 25% |
| 2.80 | 2.50 | 0.30 | 0.08 | 0.03 | 0.05 | 97% | 99% | 83% |
| 2.71 | 2.47 | 0.24 | 0.1 | 0 | 0.1 | 96% | 100% | 58% |
| 3.13 | 0.85 | 2.28 | 0.08 | 0.03 | 0.05 | 97% | 96% | 98% |
| 2.71 | 0.85 | 1.86 | 0.09 | 0.02 | 0.07 | 97% | 98% | 96% |
| 2.76 | 0.85 | 1.91 | 0.13 | 0.02 | 0.11 | 95% | 98% | 94% |
| 3.09 | 1.71 | 1.38 | 0.1 | 0 | 0.1 | 97% | 100% | 93% |
| 3.04 | 2.50 | 0.54 | 0.04 | 0.03 | 0.01 | 99% | 99% | 98% |
| 3.00 | 0.66 | 2.34 | 0.13 | 0.02 | 0.11 | 96% | 97% | 95% |
| 2.74 | 1.24 | 1.50 | 0.08 | 0 | 0.08 | 97% | 100% | 95% |
| 2.86 | 2.50 | 0.36 | 0.12 | 0 | 0.12 | 96% | 100% | 67% |
| 2.82 | 0.52 | 2.30 | 0.08 | 0 | 0.08 | 97% | 100% | 97% |
| 2.78 | 0.43 | 2.35 | 0.16 | 0 | 0.16 | 94% | 100% | 93% |
| 2.78 | 0.38 | 2.40 | 0.1 | 0 | 0.1 | 96% | 100% | 96% |
| 2.67 | 0.34 | 2.33 | 0.05 | 0 | 0.05 | 98% | 100% | 98% |
| 3.02 | 0.38 | 2.64 | 0.09 | 0 | 0.09 | 97% | 100% | 97% |
| 2.94 | 0.84 | 2.1 | 0.07 | 0 | 0.07 | 98% | 100% | 97% |

### Definitions

“Activated” means a chemical or physical process applied to a material to increase the porosity and thus the surface area. Typically it is applied to a carbon-based material, such as but not limited to bamboo, coconut husk, wood, lignite, or coal, which is then described as activated carbon. The activated carbon can be a film, powder, granular, felt, nonwoven, woven, etc.

“Adsorption” means attracting ions in an input stream to and retaining those ions on an electrode surface.

“Agglutination” means removing metal ions, halide ions, derivatives of metals or halides, or particulate metal from an input stream to a cell by one or more of the following: (i) physical adsorption; (ii) capacitive adsorption; (iii) electrochemical pH modulation & metal immobilization; (iv) electrochemical peroxide (H₂O₂) generation & metal oxidation; (v) electrodeposition or electroplating; (vi) electrochemical oxidation or reduction; (vii) precipitation; (viii) pore mouth diameter profile, (ix) electrode treatment, (x) electrode spacing, and (xi) flow-by vs. flow-through vs. carbon block cell design.

“BET surface area” means surface area determined by the Brunauer-Emmett-Teller method, which is a physical adsorption-based method using nitrogen to determine the surface area of a material.

“Breakthrough curve” means the course of an effluent adsorptive concentration at the outlet of a fixed adsorber. A breakthrough curve enables the calculation of a technically usable sorption capacity. Breakthrough curves typically plot target species concentration vs. volume treated.

“Carbon cloth” is a woven porous material consisting essentially of carbon.

‘Carbon felt” is a non-woven porous material consisting essentially of carbon.

“Carbon film” is a carbon composite consisting essentially of carbon particles and polymer binder.

“Capacitive adsorption” means adsorption of an ion or other charged species on an electrode as a result of electrical attraction.

“Cell” means, in general, a plurality of electrodes exposed to an input stream (influent), with an outlet for the output stream (effluent) during operation, a short-circuit switch or power supply attached to the electrodes, a manual or computerized means of controlling the power supply and any in-stream valves, and sensors that monitor cell operation and interface with the manual or computerized means of control. A cell can optionally include a further means of controlling the input stream and the output stream, for instance to select different output stream collection vessels or other dispositions during cell operation. Unlike a capacitive deionization cell, an faradic porosity cell (FPC) does not regenerate (aka desorb) the electrodes to produce a waste stream of desorbed target species during operation; instead, an FPC, including CCC or an EDC, is replaced, e.g., when the concentration of a target species in the output stream exceeds a user-selected threshold; replacement criteria other than target species concentration in the output stream, e.g., cumulative volume of through stream for a given FPC, and presence of certain reaction byproducts, may be specified.

“Charging potential” means a voltage applied to a cell to perform work.

“Conductivity” means the electrical conductivity of an input stream, through stream, output stream, or a waste stream. Conductivity is a surrogate measurement for the molarity of ions in an input stream, output stream, or waste stream. Conductivity is directly proportional to molarity of ions in such streams.

“CV” means cyclic voltammogram.

“Cycle” means a cycle of operation in which a sequence of positive then negative, or negative then positive, potential has been applied to an FPC electrode.

“DO” means dissolved oxygen.

“E” means a voltage, aka electrical potential; if a direct current, E has a constant polarity (positive or negative).

“Electrode” means a material, typically porous carbon, which is electrically conductive.

“EDX” means Energy Dispersive X-Ray Analysis.

“E₀” is the potential vs. a reference electrode when the electrodes are short-circuited (i.e., E₀ is the potential during a short-circuit condition).

“E_{PZC}” or “potential of zero charge”, means the potential of an electrode at which there is a minimum in ion adsorption at the surface. E_{PZC} can be intentionally shifted by surface modification of a carbon electrode, or inherently relocated as a result of oxidation of an electrode surface by extended applied potential or voltage. The E_{PZC} of a pristine carbon a electrode is typically between −0.1 V and +0.1 V. Shifting the Epzc of an electrode through surface modifications is disclosed in detail in USAPP 62/702286 incorporated herein. FPC electrode E_{PZC}s for a given target species vary by water chemistry and are empirically determined.

“Faradic immobilization” means electron transfer to a target species in the electrolyte, or electron transfer to a species in the electrolyte, followed by a homogeneous reaction in solution with the target species of interest, after which the reaction product is adsorbed on an electrode.

“Felt” is a fabric made by rolling and pressing any suitable textile accompanied by the application of moisture or heat, which causes the constituent fibers to mat together to create a smooth surface.

“Flow-by” cell design means the through stream in an FPC flows across the surface of the electrodes in an FPC, rather than through the electrodes. Flow-by cell design can provide the following advantages compared to a flow-through cell design: lower pressure drop, higher flow rate, equal degradation of carbon electrodes, equivalent pH regions generated for each electrode pair.

“Flow rate” means the flow rate, typically in L/hr, ml/min, etc., of an input, throughput, output, or waste stream.

“Flow-through” cell design means the through stream in an FPC is forced through the electrodes in an FPC. Flow-through cell design can provide the following advantages compared to a flow-by cell design: more extreme pH regions, better control over outlet pH.

“FPC” or “faradic porosity cell” or “FPC device” means a purification cell that uses agglutination to remove metal ions, halide ions, derivatives (e.g., other species) of target metals or target halides, or particulate metal from a liquid (typically aqueous) input stream and produce an output stream with a decreased metal, halide, or particulate content. Different species of FPC can be used in series or in parallel to remove target species from an aqueous influent to a purification system. An “FPC system” means a water purification system that contains one or more FPCs and optionally other types of purification cells (see definition of “hybrid system”), such as capacitive deionization (“CDI”) cells, membrane CDI cells (“MCDI”), inverted CDI (“i-CDI”) cells, and non-electrochemical cells and filters. Inclusion of CDI, MCDI, i-CDI cells, or similar desorbing cells in an FPC system requires provision of a waste stream and associated cell controls in an FPC system to accommodate desorption from CDI, MCDI, i-CDI, and similar desorbing cells into the waste stream. CCCs and EDCs are species of FPCs.

“FPC Parameter” means a user-selected value in an FPC of (i) physical adsorption; (ii) capacitive adsorption; (iii) electrochemical pH modulation; (iv) electrochemical peroxide (H₂O₂) generation & oxidation of target species; (v) electrodeposition (e.g., electroplating, electrophoretic deposition); (vi) electrochemical oxidation or reduction; (vii) precipitation; (viii) pore mouth diameter profile, (ix) electrode treatment, (x) electrode spacing, and (xi) flow-by vs. flow-through vs. carbon block cell design. One or more FPC Parameters are selected, or “tuned”, to remove a target species from a through stream, based on empirical data for a given input water chemistry.

“Halide derivative” means a molecule or compound that contains a halide.

“HE” means a high-efficiency mesoporous carbon. Electrodes made with HE carbon possess a predominately mesoporous structure with a nominal surface area of ˜380 m²/g. HE has a formulation of >98% mesoporous carbon with the balance being macroporous carbon.

“Hybrid system” means a water purification system that contains at least one FPC (CCC or EDC) and at least one other type of water purification cell, e.g., a peroxidation cell, CDI, MCDI, i-CDI, or non-electrochemical cell or filter. The minimal configuration of a hybrid system is series (FPC feeding other cell type, or vice versa). Larger systems can be series only, or have series paths in parallel (to increase throughput).

“Immobilization” means adsorption of a target species on an FPC electrode without later desorption into a purified output stream.

“Input stream” means a liquid, typically water containing various ions and metals, admitted through an inlet to a cell.

“Metal” means a metal, metal ion, metal complex, metal particle, or toxin for which a Pourbaix diagram exists and containing a metal selected from the group comprising As, Se, Pb, Ni, Zn, Al, Sc, Ti, V, Cr, Mn, Fe, Co, Ni, Cu, Y, Zr, Nb, Mo, Tc, Ru, Rh, Pd, Ag, Cd, La, Hf, Ta, W, Re, Os, Ir, Pt, Au, Hg, Ce, Pr, Nd, Pm, Sm, Eu, Gd, Tb, Dy, Ho, Er, Tm, Yb, and Lu.

“Metal derivative” means a molecule or compound that contains a metal or metalloid.

“Metal speciation” means the different chemical forms (“species”) of a metal in a given milieu. For instance, As(III) and As(V) are species of arsenic that can coexist in an aqueous solution at a given pH.

“NHE” means Normal Hydrogen Electrode.

“Nonwoven” means sheet or web structures bonded together by entangling fiber or filaments (and by perforating films) mechanically, thermally or chemically.

“Output stream” means a liquid that has passed through an FPC and contains a lower molarity of target species than in the input stream.

“Parallel system architecture” means FPCs (and optionally other types of cells and filters) connected in parallel, i.e., the outlet of each FPC (and optionally other types of cells and filters) feeds the system output. A parallel system architecture can be fixed, or can comprise multiple FPCs, a process controller, interconnecting lines, sensors, and valves disposed in the lines and cells.

“Physical adsorption” means physical entrapment of a target species in an electrode pore.

“PMD” means pore mouth diameter, which is the diameter of a pore on the surface of a carbon electrode. A pore may be a dead-end channel or a through channel within a carbon electrode, and typically has a variable channel diameter.

“Point of entry” or “POE” means the location where a water supply feeds a water distribution system in a residence, commercial/industrial building, or other structure.

“Point of use” or “POU” means the location where water is dispensed from a water distribution system to a consumer, beverage dispenser, kitchen appliance, or other end use.

“Polarity” means the polarity of a DC voltage, either positive or negative.

“Pore mouth diameter profile” means the volumetric ratio(s) among microporous, mesoporous, and macroporous carbon in an electrode. Generally speaking, the larger the average pore mouth diameter, the longer the working lifetime of the electrode and the more permeable the electrode is to a through stream. The average pore mouth diameter is controlled by the ratio of microporous, mesoporous, and macroporous carbon used to fabricate a given carbon electrode.

“Pourbaix diagram” (aka potential/pH diagram, EH-PH diagram or a pE/pH diagram), maps out possible stable (equilibrium) phases of an aqueous electrochemical system. Predominant ion boundaries are represented by lines. As such, a Pourbaix diagram can be read much like a standard phase diagram with a different set of axes. Similar to phase diagrams, Pourbaix diagrams do not address reaction rate or kinetic effects. For soluble species, the lines in a Pourbaix diagram are usually drawn for concentrations of 1 M or 10⁻⁶ M. Sometimes additional lines are drawn for other concentrations.

“Pourbaix operating region” means relating the pH and applied E at a given electrode in an FPC to a Pourbaix diagram to select for immobilization of a target species in a given water chemistry.

“Pristine” in reference to electrodes means without surface modifications; for example, a Spectracarb™ electrode, as supplied by the manufacturer, is pristine.

“Process controller” means a computer operating a process control application that monitors sensors disposed in a system of FPCs (and optionally, other types of cells and filters) to sample input, through, and/or output streams and status of FPCs (and optionally, other types of cells and filters) in a water purification system comprising one or more FPCs and optionally one or more other types of water purification cells or filters. The process controller actuates valves in lines interconnecting a source of aqueous solution to be treated, FPCs (and optionally other cells and filters), and system outlets, thereby enabling the various FPCs (and optionally other cells and filters) to be configured in a series system architecture, series-parallel system architecture, or parallel system architecture. Based on sensor data, the process controller can dynamically adjust FPC Parameters of FPCs in the system (and optionally adjust other cells and filters in the system).

“Purify” means to remove one or more target species from a through stream. Purification includes the removal of metals for which a Pourbaix diagram exists (e.g., As, Pb, Ni, Zn, Al, Cr, Mn, Fe, and Cu), halides (e.g., CI, Br, chloramines), organics, and biological compounds.

“Rolled cell design” means an FCP cell design in which continuous separator and porous carbon-based electrode materials are physically rolled into a spiral to create a cylinder with multiple, predominantly flow-by, through stream paths through the porous carbon electrodes. To make a rolled cell, sheets of anode material, separator material, and cathode material are stacked and then rolled up to form a cylinder. Current collectors are attached to the anode and the cathode, usually in multiple locations to reduce electrical losses.

“SCE” means a saturated calomel electrode, a standard reference electrode commonly used as a reference electrode, e.g., in cyclic voltammetry.

“Series system architecture” means FPCs (and optionally, other types of cells and filters) connected in series, i.e., the outlet of a first FPC feeds the inlet and a second FPC, the outlet of the second FPC feeds the inlet and a third FPC, and so on. A series system architecture can be fixed, or can comprise multiple FPCs (and optionally, other types of cells and filters), a process controller, sensors, interconnecting feed lines, and valves disposed in feed lines between the outlet of one FPC and the inlet of a second FPC.

“Series-parallel system architecture” means a system in which FPCs (and optionally, other types of cells and filters) can be connected in series or in parallel. A series-parallel system architecture can be fixed, or can comprise multiple FPCs (and optionally, other types of cells and filters), a process controller, interconnecting feed lines, sensors, and valves disposed in feed lines between the outlet of one FPC and the inlet of a second FPC, which valves are actuated by the process controller. The typical series-parallel system architecture comprises multiple ranks of a given series of cells, thereby treating the through stream in the same way, but with higher throughput provided by multiple serial paths.

“SHE” means Standard Hydrogen Electrode.

“Shift” means to alter the potential (aka “location”) of the E_{PZC} of an electrode by intentional or unintentional chemical or electrochemical modification of the electrode surface (e.g., electrochemical oxidation due to an applied potential or voltage).

“Species” means a molecule, compound, or particulate in an aqueous stream or adsorbed on a cell electrode.

“Speciation” means the distribution of an element among defined chemical species in a system or within an FPC. For instance, an uncharged metal particle, a metal ion, and a metal complex of a given metal may coexist in solution or suspension at a given pH, which distribution may change as pH changes.

“Stacked cell design” means an FCP cell design in which separate pieces of separator and porous carbon-based electrode materials are stacked layer-by-layer to create a cylinder with multiple, predominantly flow-by, through stream paths through and/or by the porous carbon electrode. Current collectors are attached to the anode and the cathode, usually in multiple locations to reduce electrical losses. FIG. 1 shows an example of a stacked cell design.

“Surface-charge enhanced surface” means an electrode surface that has been imparted with surface charge through chemical or electrochemical methods.

“System” is a plurality of interconnected FPCs (and optionally, other types of cells and filters) controlled manually or by a process controller.

“Target metal” means one or more species of a given metal or metal derivative to be removed.

“Target speciation” means one of several ionic states or complexations a target species may assume in an aqueous electrochemical cell as a function of E applied to cell electrodes and pH, as shown in a Pourbaix diagram of the target species.

“Target species” means a molecule, compound, or particulate to be removed using an FPC. “Target species” includes not only the molecule, compound, or particulate as found (aka “identified as a species in a Pourbaix diagram”) in the input stream to an FPC, but one or more intermediate and final reactive products created in an FPC that include that molecule, compound, or particulate.

“Through stream” means the liquid stream being treated within a cell; stated differently, the through stream means the stream within a cell and between the inlet to the cell and the outlet from the cell.

“Treat” means to feed an input stream into an operating FPC or system containing FPCs and to recover the purified output stream.

“Treated electrode” means an electrode with an electrode surface modification disclosed herein.

“TDS” means total dissolved solids. The general operational definition is that the solids must be small enough to survive filtration through a filter with two-micrometer pores.

“Untreated electrode” means an electrode without an electrode surface modification disclosed herein, i.e., a pristine carbon electrode.

“Voltage” and “potential” are synonymous herein. Voltage is direct current (“DC”) unless otherwise specified.

“Waste stream” means a liquid that has passed through a CDI, MCDI, i-CDI cell, reverse osmosis, ion exchange, or other water purification cell that cycles between adsorption and desorption and contains a higher molarity of ions than in the input stream. Deionization cells, e.g., capacitive deionization cells, can be used in a system containing FPCs. An FPC does not have a waste stream: the output stream from an FPC is purified water. A system that contains deionization cells that periodically desorb molecules will have (i) a purified output stream from deionization cells operating in an adsorption state that is combined with FPC output streams, and (ii) a waste stream from deionization cells operating in a desorption state.

“Woven cloth” is any textile formed by weaving

It is to be understood that the phraseology and terminology employed herein are for the purpose of description and should not be regarded as limiting. As such, those skilled in the art will appreciate that the conception, upon which this disclosure is based, may readily be utilizedas a basis for the designing of other structures, methods, and systems for carrying out the presentinvention. It is important, therefore, that the claims be regarded as including such equivalent constructions insofar as they do not depart from the spirit and scope of the present invention.

Other advantages and capabilities of the invention will become apparent from the description above taken in conjunction with the accompanying drawings showing the embodiments and aspects of the present invention.

1. An electrochemical device for at least partially removing or reducing a target ionic species from an aqueous solution using faradaic immobilization, the electrochemical device comprising:
at least one first electrode comprising an activated carbon film having a void fraction of about 10% to about 75% and a surface area of about 600 square meters per gram to about 2,000 square meters per gram; and
at least one second electrode comprising a carbon-based material having a void fraction of about or greater than 95% and a surface area of about 0.1 square meters per gram to about 5 square meters per gram.

2. The electrochemical device of claim 1, wherein the activated carbon film of the at least one first electrode is microporous.

3. The electrochemical device of claim 1, wherein the activated carbon film of the at least one first electrode comprises a binder.

4. The electrochemical device of claim 3, wherein the binder comprises polyvinylidene fluoride (PVDF), polytetrafluoroethylene (PTFE), sodium alginate, sodium-carboxymethyl cellulose, an ion exchange binder or a combination thereof.

5. The electrochemical device of claim 1, wherein the at least one second electrode comprising the carbon-based material is a carbon felt.

6. The electrochemical device of claim 1, wherein the at least one first electrode is a cathode.

7. The electrochemical device of claim 1, wherein the at least one first electrode is an anode.

8. The electrochemical device of claim 1, wherein the at least one second electrode is a cathode.

9. The electrochemical device of claim 1, wherein the at least one second electrode is an anode.

10. The electrochemical device of claim 1, wherein the aqueous solution flows through the at least one second electrode.

11. The electrochemical device of claim 1, wherein the electrochemical device is a rolled device.

12. The electrochemical device of claim 1, wherein the electrochemical device is a stacked device comprising a plurality of the at least one first electrode and a plurality of the at least one second electrode.

13. The electrochemical device of claim 1, wherein the target ionic species is silver, copper, chromium, lead, manganese, nickel, zinc, chlorine, chloramine, or any combination thereof.

14. The electrochemical device of claim 13, wherein the chromium is Cr (VI) and is reduced to Cr (III).

15. The electrochemical device of claim 1, wherein the activated carbon film has a void fraction of about 10% to about 15%; a surface area of about 800 to about 1,000 square meters per gram; a density of about 1.0 to about 1.5 grams per cubic centimeter; an areal density of about 200 to about 500 grams per square meters; a microporous pore size; or any combination thereof.

16. The electrochemical device of claim 15, wherein the activated carbon film has a void fraction of about 60% to about 80%; a surface area of about 1,800 to about 2,000 to square meters per gram; a density of about 0.4 to about 0.8 grams per cubic meter; an areal density of about 60 to about 100 grams per square meter; a microporous pore size; or any combination thereof.

17. The electrochemical device of claim 1, wherein the activated carbon film has a void fraction of about 50% to about 70%; a surface area of about 1,100 to about 1,500 square meters per gram; a density of about 0.5 to about 0.9 grams per cubic meter; an areal density of about 140 to about 180 grams per square meter; a microporous pore size; or any combination thereof.

18. The electrochemical device of claim 1, wherein the activated carbon film has a void fraction of about 30% to about 60%; a surface area of about 600 to about 900 square meters per gram; a density of about 0.5 to about 0.9 grams per cubic meter; an areal density of about 140 to about 170 grams per square meter; a microporous pore size; or any combination thereof.

19. The electrochemical device of claim 1, wherein the at least one second electrode comprising the carbon-based material has a void fraction of about 96% to about 99%; a surface area of about 0.1 to about 1 square meters per gram; a density of about 0.01 to about 0.2 grams per cubic meter; an areal density of about 100 to about 400 grams per square meter; a microporous pore size; or any combination thereof.
